(19) United States
(12) Patent Application Publication
(10) Pub. No.: US 2006/0028007 A1
(43) Pub. Date: Feb. 9, 2006

(54) Driver's seat with weight sensor

(76) Inventors: Thomas Lehnst, Braunschweig (DE); Arne Stahl, Gifhorn (DE); Christian Hons, Braunschweig (DE); Rudiger Prang, Braunschweig (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/197,565

(22) Filed: Aug. 4, 2005

Related U.S. Application Data
(63) Continuation of application No. PCT/EP04/00533, filed on Jan. 23, 2004.

(30) Foreign Application Priority Data
Feb. 5, 2003 (DE) 103 04 570.8

(51) Int. Cl. B60R 21/16; G01G 19/52; B60K 28/04

(52) U.S. Cl. 280/735; 177/144; 180/273; 73/768; 73/775

(57) ABSTRACT

A driver's seat comprises a weight-sensing mechanism for a motor vehicle. In order to optimize a vehicle seat of the generic type in such a way that very reliable weight measurement is obtained for the indicated purpose, the seat is provided with at least one seat tub (1) into which at least one additional planar element (10) is inserted while at least one weight sensor (20) is disposed between the seat tub (1) and the planar element (10).

### CROSS-REFERENCE TO RELATED APPLICATIONS

This application is a continuation of co-pending International Application No. PCT/EP2004/000533 filed Jan. 23, 2004, which designates the United States and claims priority to German Application No. DE 103 04 570.8 filed Feb. 5, 2003, the contents of which are hereby incorporated by reference in their entirety.

### TECHNICAL FIELD

The invention concerns a driver's seat with weight sensor for a vehicle.

### BACKGROUND

Vehicle seats are known from the prior art, in which weight sensors are arranged. The reason for this is logical self-recognition of the state, whether the vehicle seat is occupied or not, in order to operate safety systems, like airbags, belt tighteners, etc., only with seat-related necessity. The advantage here is that replacing an airbag is relatively costly, for example. If this were triggered in a passenger seat without a person being seated there at the decisive point, then it would be needlessly triggered.

In addition, there is another task for weight sensors in vehicle seats. With the sensor, the weight of the person can be determined and the safety systems, as required, optimally triggered based on body weight.

In this case, the weight sensors are provided, for example, as strain gauges. They must then be positioned at an appropriate location.

In addition, it is known that the weight of a person occupying the seat is distributed on the seat surface. It is therefore difficult to perform a precise measurement.

Even the arrangement of a sensor array distributed over a surface provides only partial success on the way toward optimizing this weight measurement.

### SUMMARY

With this as point of departure, the underlying object of the invention is to optimize a vehicle seat of the generic type, so that very reliable weight measurement is achieved for the mentioned purpose.

This object can be achieved by a vehicle seat comprising at least one seat trough, in which at least one additional flat element is inserted, and at least one weight sensor is arranged between the seat trough and the flat element.

The additional flat element can be an additional seat trough that extends at least partially over the inside surface of the first seat trough. The arrangement of two seat troughs can be arranged beneath the seat cushion. The seat trough or the seat troughs can be divided into regions. The regions can be movable or pivotable or tiltable relative to each other. The zone divisions of seat troughs can be congruent. The weight sensors can be arranged in the vicinity of the zone transitions or region transitions. The sensors can be arranged distributed as multiple sensors. The position sensors can be arranged redundantly. The sensors arranged in distributed fashion can be arranged in pairs.

The core of the invention is that the seat contains at least one seat trough, in which at least one additional flat element is inserted and at least one weight sensor is arranged between the seat trough and the flat element. Because of this, the surface distribution that the person on the seat surface generates is considered and the pressure force of the flat element on the seat trough generated by the weight force is determined.

In another advantageous embodiment, it is stated that the additional flat element is an additional seat trough that extends at least partially over the inside surface of the first seat trough. Because of this, a so-called trough-in-trough principle is produced. Because of the defined weight-dependent pressing of the seat troughs one into the other, a defined force determination is produced and therefore a defined weight force determination.

In another advantageous embodiment, it is stated that the seat trough arrangement is arranged beneath the seat cushion.

In addition, it is advantageously configured, so that at least one of the seat troughs is divided into zones. An advantageous seat trough, as a substructure for a vehicle seat, is known from DE 100 01 445 A1. However, this consists of a coherent seat trough, which, however, is subdivided into different zones, like a two-part seat surface zone and a back zone. These can be tilted relative to each other via flexible elements or areas and therefore follow the adjustment possibilities of a vehicle seat. This principle is further developed decisively in the present invention. Two troughs are used, between which at least one weight sensor is arranged. Segmenting or subdivision into different areas is also a great advantage in the present vehicle seat according to the invention.

In another advantageous embodiment, at least one seat trough is provided with zones that can be moved or tilted relative to each other. The seat trough gains the mobility that it must have to exercise the adjustment possibilities of the seat.

In another advantageous embodiment, it is stated that the zone division, i.e., the deformable connection areas between zones, is present in each of the troughs and these are arranged spatially in roughly the same location, when the troughs are inserted one into the other. The trough-in-trough arrangement therefore overall acquires good mobility. This means that the trough-in-trough principle can be implemented without adversely affecting the adjustment flexibility of the seat.

In an advantageous embodiment, the sensor or sensors are arranged in the vicinity of the zone transitions.

In another advantageous embodiment, it is stated that several sensors are provided. The system is redundant to a certain extent on this account. However, the possibility is gained of configuring the weight determination as self-checking for plausibility.

In another advantageous embodiment, it is therefore stated that several sensors can be arranged in distributed fashion. A very reliable measurement method is produced by this that can encompass the entire seat surface.

In order to design this method of measurement even more redundant, the sensors can be arranged in pairs at each sensor point in this “network of sensors”.

### BRIEF DESCRIPTION OF THE DRAWINGS

The invention is depicted in the drawings and further described below.

In the drawing:

FIG. 1 shows a schematic view of the trough-in-trough principle.

FIG. 2 shows a detailed depiction.

### DETAILED DESCRIPTION

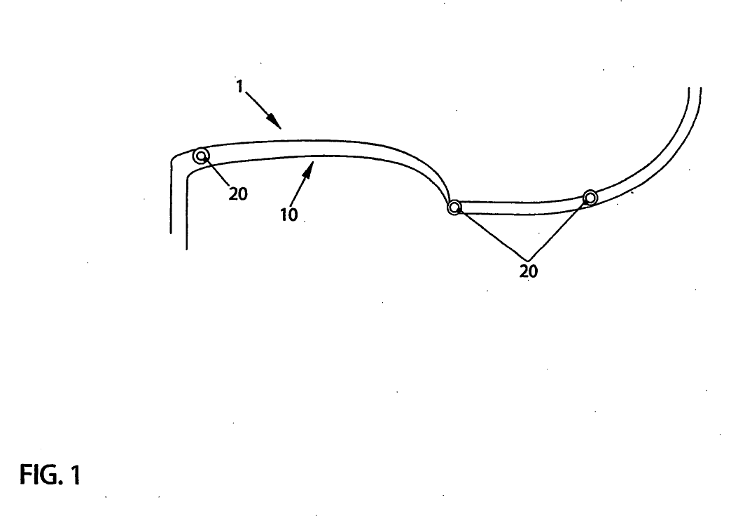

FIG. 1 shows the part of the driver's seat according to the invention, namely, the seat trough 1 and 10 in a side view. The trough-in-trough principle is already satisfied here, namely, two seat troughs are inserted one into the other. Between the two troughs 1 and 10, weight sensors 20 are positioned at the marked locations. Since the weight force of the person on the entire seat surface is distributed differently, sensors arranged with different distribution are provided for this reason. These pick up corresponding partial weight forces.

In this example, several individual weight force sensors are shown. However, it is also advantageous to arrange a sort of network of sensors over the relevant seat surface parts. For this purpose, so-called sensor pads could be used, which produce a sensor pad from a flat network of sensors distributed in a grid-like pattern, the pad then being positioned in a relevant region.

In any design, the sensors are arranged directly in the region between the seat troughs. The seat structure as such is then constructed layered and contains cushioning layers, optionally a heating element, and a one- or multilayer cover. Since the weight force of the person is distributed relatively diffusely over the cushioning layer, the essence of the invention comes to bear here. The weight force, however it is distributed in the cushion as a whole, is picked up by the upper seat trough 1. This gives the surface on which the weight force is measured a defined contour. From there, the weight force is transferred to a second seat trough 10, which is recorded as a whole at least at the relevant sites between the troughs by sensors 20.

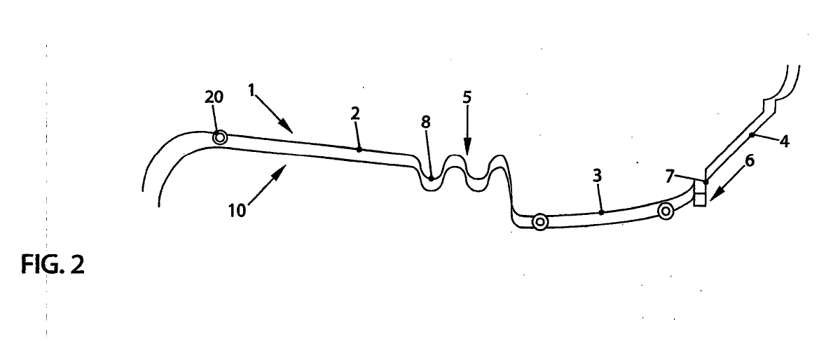

FIG. 2 shows a detailed view of the employed seat troughs 1 and 10. The usability of the one-part seat trough is prominent here. The seat troughs as such should be one-part, if possible, but permit tilt adjustments of the seat structure as such.

For this purpose, each seat trough has profiled zones, so that the bending resistance of the seat plate is reduced there. The one-part seat plate, as already stated, offers the possibility of consistently using the trough-in-trough principle according to the invention and implementing a favorable sensor distribution in between, but, on the other hand, obtaining full adjustment flexibility of the seat as a whole.

It is advantageous here, if several grooves running across the pivot direction form a meander-like cross sectional profile. High local stress during relative displacements of the intermeshing trough regions is avoided on this account. Full seat tilt adjustment is provided.

The trough zone designated 1 contains three regions 2, 3 and 4 that can be pivoted relative to each other. Region 4 is fastened to a vehicle frame. The front region 2 is supported on a known tilt adjustment device. Because of this it is possible to pivot the two regions 2 and 3, for example, into higher positions relative to the rear-most region 4, so that a change in tilt of the seat surface is achieved, extending almost over the entire length of seat trough 1.

An equivalent seat trough that also has flexible bending zones now lies on the lower seat trough. If the trough position one in the other, the meander-like grooves of the two troughs running transversely are congruent to each other, so that the trough-in-trough structure also remains bendable at these sites and makes said adjustments possible.

Between the adjacent trough regions 2, 3 and 4, there are zones 5 and 6 of reduced bending resistance in the plane of the drawing. These zones are formed by a transversely running, groove-like profile 7 in the case of zone 6, as well as a number of groove-like profiles 8 in the case of zone 5; these groove-like profiles 8, as a whole, as shown in the figure, form a meandering cross sectional profile that distributes the stresses occurring during pivoting over a relatively large length region of trough 1 and therefore over the seat.

The supplies for both troughs 1 and 2 are inserted one in the other. Between them, the weight force sensors are positioned, either individually or as a sensor pad.

What is claimed is:

1. A vehicle seat comprising at least one seat trough, in which at least one additional flat element is inserted, and at least one weight sensor is arranged between the seat trough and the flat element.

2. A vehicle seat according to claim 1, wherein the additional flat element is an additional seat trough that extends at least partially over the inside surface of the first seat trough.

3. A vehicle seat according to claim 2, wherein the arrangement of two seat troughs is arranged beneath the seat cushion.

4. A vehicle seat according to claim 1, wherein the seat trough is divided into regions.

5. A vehicle seat according to claim 1, wherein the regions are movable or pivotable or tiltable relative to each other.

6. A vehicle seat according to claim 1, wherein the zone divisions of seat troughs are congruent.

7. A vehicle seat according to claim 1, wherein the weight sensors are arranged in the vicinity of the zone transitions or region transitions.

8. A vehicle seat according to claim 1, wherein the sensors are arranged distributed as multiple sensors.

9. A vehicle seat according to claim 1, wherein the position sensors are arranged redundantly.

10. A vehicle seat according to claim 9, wherein the sensors arranged in distributed fashion are arranged in pairs.

11. A vehicle seat comprising a first seat trough in which at least a second seat trough is inserted, and at least one weight sensor is arranged between the first and second seat trough.

12. A vehicle seat according to claim 11, wherein the second seat trough extends at least partially over the inside surface of the first seat trough.

13. A vehicle seat according to claim 12, wherein the arrangement of two seat troughs is arranged beneath the seat cushion.

14. A vehicle seat according to claim 11, wherein the seat troughs are divided into regions.

15. A vehicle seat according to claim 11, wherein the regions are movable or pivotable or tiltable relative to each other.

16. A vehicle seat according to claim 11, wherein the zone divisions of seat troughs are congruent.

17. A vehicle seat according to claim 11, wherein the weight sensors are arranged in the vicinity of the zone transitions or region transitions.

18. A vehicle seat according to claim 11, wherein the sensors are arranged distributed as multiple sensors.

19. A vehicle seat according to claim 11, wherein the position sensors are arranged redundantly.

20. A vehicle seat according to claim 19, wherein the sensors arranged in distributed fashion are arranged in pairs.
